(19) United States
(12) Patent Application Publication
(10) Pub. No.: US 2016/0021161 A1
(43) Pub. Date: Jan. 21, 2016

(54) MOBILE NETWORK VIDEO OPTIMIZATION FOR CENTRALIZED PROCESSING BASE STATIONS

(71) Applicant: Alcatel-Lucent USA, Inc., Murray Hill, NJ (US)

(72) Inventor: Harish VISWANATHAN, Morristown, NJ (US)

(21) Appl. No.: 14/332,512

(22) Filed: Jul. 16, 2014

(51) Int. Cl. H04L 29/06

(52) U.S. Cl. CPC H04L 65/602; H04L 65/80; H04L 69/22

(57) ABSTRACT

In one example embodiment, a base band unit includes a processor. The processor is configured to receive video data, adjust a quality of the video data based on network information corresponding to a cell site serviced by a base station and send the adjusted video data to the base station.

### BACKGROUND

Video data makes up 50% of the data traffic in mobile networks and is expected to increase to 70% by the year 2017. Optimization of video data both improves the quality of experience of mobile users accessing such video data while at the same time reduces the cost of video data delivery.

Network operators have deployed video optimization solutions that are typically implemented outside of the mobile networks and at best takes into consideration historical data across all devices (e.g., historical data on average network throughput for all devices in a mobile network), when optimizing video data.

However, for mobile networks in which the users' radio conditions and cell congestion conditions can change rapidly, optimization of video data by taking into consideration the user radio condition and the local cell congestion of the cell serving each user is needed.

### SUMMARY

Some embodiments relate to methods and apparatuses for performing video optimization of video data to be sent to a user device by taking into account local radio conditions and cell congestions of a cell serving the user.

In one example embodiment, a base band unit includes a processor. The processor is configured to receive video data, adjust a quality of the video data based on network information corresponding to a cell site serviced by a base station and send the adjusted video data to the base station.

In yet another example embodiment, the processor is configured to perform a first processing of the received video data, adjust the quality of the video data and perform a second processing of the video data having the adjusted quality, prior to sending the adjusted video data to the base station.

In yet another example embodiment, the first processing includes removing tunnel headers of an Internet Protocol (IP) packet that includes the video data, upon receiving the IP packet.

In yet another example embodiment, the processor is further configured to determine whether to perform the adjusting of the quality of the video data upon removing the tunnel headers, and adjust the quality of the video data upon determining that the quality of the video data is to be adjusted.

In yet another example embodiment, the baseband unit and the base station are co-located in the same geographical location

In yet another example embodiment, the network information includes at least one of a real-time network throughput to a user device to which the video data is to be transmitted and is served by the base station and overall resource utilization by user devices at a cell site served by the base station.

In yet another example embodiment, the processor is configured to adjust the quality of the video data to provide an uninterrupted streaming of the video data at a user device serviced by the base station.

In yet another example embodiment, the processor is further configured to query information associated with Layer 2 processing performed by the processor for the network information and adjust the quality of the video data based on the queried network information.

In yet another example embodiment, the processor is configured to periodically query the information associated with the Layer 2 processing.

In yet another example embodiment, the processor is configured to adjust the quality of the video data based on the network information as well as characteristics of a user device to which the video data is to be sent.

In one example embodiment, a method includes receiving video data by a processor, adjusting a quality of the video data based on network information corresponding to a cell site serviced by a base station and sending the optimized video data to the base station.

In yet another example embodiment, the method further includes first processing the received video data and second processing of the video data, wherein the adjusting adjust the quality of the video data after the first processing but prior to the second processing, and the second processing second processes the video data whose quality is adjusted before the sending sends the video data to the base station.

In yet another example embodiment, the first processing includes removing tunnel headers of an Internet Protocol (IP) packet that includes the video data, upon receiving the IP packet, and the method further includes determining whether the quality of the video data of the IP packet is to be adjusted, wherein the adjusting adjusts the quality of the video data if the determining determines that the quality of the video data is to be adjusted.

In yet another example embodiment, the network information includes at least one of a real-time network throughput at a user device to which the video data is to be transmitted and is served by the base station, overall resource utilization by user devices at a cell site served by the base station and characteristics of a user device to which the video data is to be sent.

In yet another example embodiment, the adjusting adjusts the quality of the video data to provide an uninterrupted streaming of the video data at a user device services by the base station.

In yet another example embodiment, querying information associated with Layer 2 processing performed by the processor for the network information, wherein the adjusting adjusts the quality of the video data based on the queried network information.

In yet another example embodiment, the querying periodically queries the information associated with the Layer 2 processing.

In one example embodiment, a processing unit is configured to receive video data from a base band unit, adjust a quality of the video data based on network information corresponding to a cell site serviced by a base station associated with the base band unit, and send the adjusted video data to the base band unit.

In yet another example embodiment, the processing unit and the base band unit are co-located in the same unit.

In yet another example embodiment, the base band unit is configured to remove tunnel headers of an IP packet received at the base band unit, and the processor is configured to determine whether to perform the adjusting of the quality of the video data of the IP packet and adjust the quality of the video data upon determining that the quality of the video data is to be adjusted.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present disclosure, and wherein:

FIG. 1 illustrates a mobile network including a video processor, according to one example embodiment;

FIG. 2 illustrates a process for adjusting a quality of video data by a base band unit of a mobile network, according to an example embodiment;

FIG. 3 illustrates a process performed by a packet inspector of a base band unit, according to one example embodiment; and

FIG. 4 illustrates a processing for adjusting video data by a video processor of the base band unit, according to one example embodiment.

### DETAILED DESCRIPTION OF EXAMPLE EMBODIMENTS

Various embodiments will now be described more fully with reference to the accompanying drawings. Like elements on the drawings are labeled by like reference numerals.

Detailed illustrative embodiments are disclosed herein. However, specific structural and functional details disclosed herein are merely representative for purposes of describing example embodiments. This disclosure may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs), computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware, or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory content. Information, arguments, parameters, data, etc. may be passed, forwarded, or transmitted via any suitable means including memory sharing, message passing, token passing, network transmission, etc.

Example embodiments may be utilized in conjunction with Radio Access Networks (RANs) such as: Universal Mobile Telecommunications System (UMTS); Global System for Mobile communications (GSM); Advance Mobile Phone Service (AMPS) system; the Narrowband AMPS system (NAMPS); the Total Access Communications System (TACS); the Personal Digital Cellular (PDC) system; the United States Digital Cellular (USDC) system; the code division multiple access (CDMA) system described in EIA/TIA IS-95; a High Rate Packet Data (HRPD) system, Worldwide Interoperability for Microwave Access (WiMAX); Ultra Mobile Broadband (UMB); and 3^{rd} Generation Partnership Project LTE (3GPP LTE).

As described above, video data optimization taking into consideration local radio conditions at a cell site serving a mobile device that has requested the video data, both increases the quality of experience by the user of the mobile device while at the same time reduces the cost of video data delivery. In some example embodiments presented herein, video data optimization may refer to adjustments made to the video data so as to provide a user of user device receiving the video data a consistent and uninterrupted stream of the video data. Hereinafter optimization of video data and adjustment of video data may be used interchangeably.

With evolution of the radio access network architecture from the current distributed architecture where all the base band processing is implemented at the cell site, to a centralized architecture where the layer 2 and layer 3 processing are performed centrally in a cell site's local data center, an opportunity for efficient video data adjustment in the same local data center arises. Unlike prior solutions where a local packet gateway is required to route the video traffic from/to a local video server, where video data may be optimized, it is possible to implement the video adjustment between the Layer 2 and Layer 3 processing of the base band unit (BBU). In some example embodiments, video data adjustment is part of the service chain function between Layer 2 and Layer 3 processing.

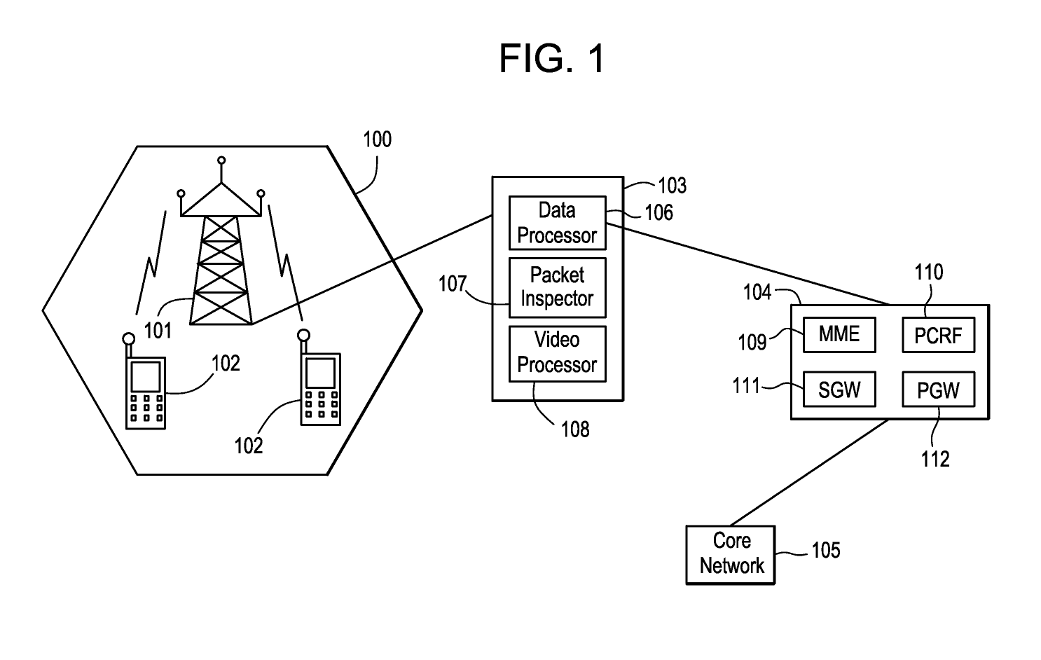

FIG. 1 illustrates a mobile network including a video processor, according to one example embodiment. FIG. 1 illustrates a mobile network including a base station 101 servicing a cell site 100 and one or more user devices 102 within the cell site, a BBU 103 and an evolved packet core (EPC) 104. The mobile network may communicate with a core network 105 via the EPC 104.

The BBU 103 may include components including, but not limited to, a data processor 106, a packet inspector 107 and a video processor 108. In one example embodiment, the BBU 103 may be associated with the cell site 100 only. Alternatively, the BBU 103 may service two or more cell sites and the base stations servicing such cell sites.

While FIG. 1 illustrates the BBU 103 as including the data processor 106, the packet inspector 107 and the video processor 108, in some example embodiments, the BBU 103 may only include the data processor 106 (e.g., perform the functions of the data processor 106 but not that of the packet inspector 107 and the video processor 108) but at the same time be co-located with another component that includes the packet inspector 107 and the video processor 108.

The functions performed by the data processor 106, the packet inspector 107 and the video processor 108 will be further described below. In one example embodiment, the BBU 103 may include a processor (not shown), that executes instructions and is configured as a special purpose machine for performing the functions (to be described) of the data processor 106, the packet inspector 107 and the video processor 108.

Alternatively and in the example embodiments in which the BBU 103 does not include the packet inspector 107 and the video processor 108, said processor is configured to perform the functions of the data processor 106 only (e.g., Layer 1 and/or Layer 2 and Layer 3 processing). Accordingly, the component that includes the packet inspector 107 and the video processor 108 also includes a processor that executes instructions and is configured as a special purpose machine for performing the functions of the packet inspector 107 and the video processor 108.

The EPC 104 may include components including, but not limited to, a mobility management entity (MME) 109, a policy and charging rules function (PCRF) 110, a serving gateway (SGW) 111 and a packet gateway (PGW) 112. In one example embodiment, video data may be received at the base station 101 from the core network 105 via the SGW 111 and the PGW 112.

In one example embodiment, the EPC 104 may include a processor (not shown) that executes instructions and is configured as a special purpose machine for performing the functions of the MME 109, the PCRF 110, the SGW 111 and the PGW 112.

The cell site 100 may be serviced by more than one base station such as the base station 101. The one or more base stations 101 may be in communication with the BBU 103, which in one example embodiment is local to the cell site 100. The communication between the base station 101 and the BBU 103 may be wired and/or wireless. In one example embodiment, the BBU 103 may be embedded within and/or co-located in the same geographical location with the base station 101.

In the example embodiments in which the BBU 103 is not co-located with the base station 101, the base station 101 may be a remote radio head with capabilities of performing Layer 1 processing only, while the Layer 2 and Layer 3 processing are implemented at the remote BBU 103.

Various signal processing operations on signals to be communicated to or from the user devices 102 may be performed at the BBU 103. The base station 101 may be a Long Term Evolution (LTE) e-Node B. The user devices 102 may be any one of, but not limited to, a mobile phone, a tablet, a laptop, etc. The number of user devices 102 is not limited to two as shown in FIG. 1 but may include any number of devices present in the cell site 100 that are served by the base station 101 and/or any other base stations serving the cell site 100.

The data processor 106 of the BBU 103 may perform functions including, but not limited to, Layer 1, Layer 2 and Layer 3 processing on data received at the BBU 103. Layer 1, Layer 2 and Layer 3 processing are known to those skilled in the art.

The packet inspector 107 may be a deep data inspection (DPI) unit and/or a HTTP proxy server. The data processor 106, the packet inspector 107 and the video processor 108 may be in communication with one another.

As described above, existing solutions perform the video optimization outside the mobile network. For example, according to existing solutions, the video processor 108 is located outside the mobile network (e.g., between the EPC 104 and the core network 105). Such a video processor fails to perform video quality adjustment based on real time local radio network conditions, which in turn results in lower quality of experience for a user of a user device receiving the video data (e.g., interruption in video streaming and or streaming video with lower quality) and/or increase the cost of delivery of the video data (e.g., costs associated with resending video data that fails to reach the intended user device).

However, according to example embodiments described herein and as depicted in FIG. 1, the packet inspector 107 and the video processor 108 are co-located with the data processor 106 within the BBU 103 (e.g., the packet inspector 107 and the video processor 108 are part of the mobile network) or alternatively form a separate component that is co-located with the BBU 103 in the same location. Therefore, given that the BBU 103 services the cell site 100, the packet inspector 107 and the video processor 108 will be able to take into consideration the network conditions at the local cell site 100, when adjusting the quality of the video data destined for the user devices 102. Doing so enhances the user's quality of experience and reduces the cost of delivery of the video data. In one example embodiment, the adjustment of the video data by the video processor 108 is performed between the Layer 3 and Layer 2 processing by the data processor 106.

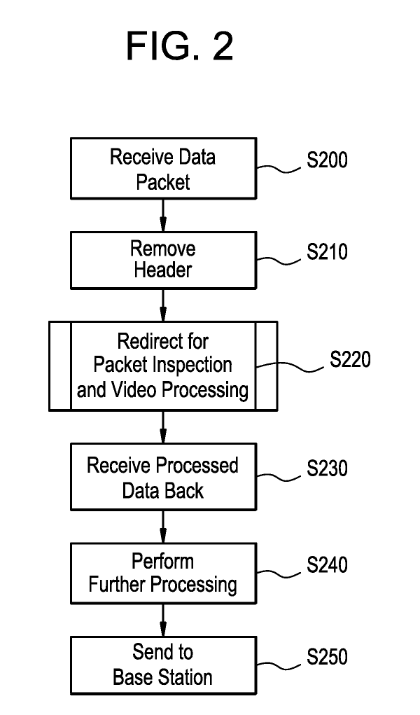

Hereinafter, the functionalities of the data processor 106, the packet inspector 107 and the video processor 108 will be described with respect to FIGS. 2-4.

FIG. 2 illustrates a process for adjusting a quality of video data by a base band unit of a mobile network, according to an example embodiment. When a video data packet is sent to the base station 101 (e.g., via the SGW 111 and the PGW 112), the GPRS Tunneling Protocol (GTP) flow carrying the IP packet that contains video data packet is terminated at the base station 101. The GTP flow is initially received at the data processor 106.

At S200, the data processor 106 of the BBU 103 receives a data packet (e.g. IP packet) that carries video data. At S210, the data processor 106 removes the tunnel header from the received data packet to retrieve the raw IP packet. The removing of the tunnel header from the received data packet may be done at the Layer 3 processing.

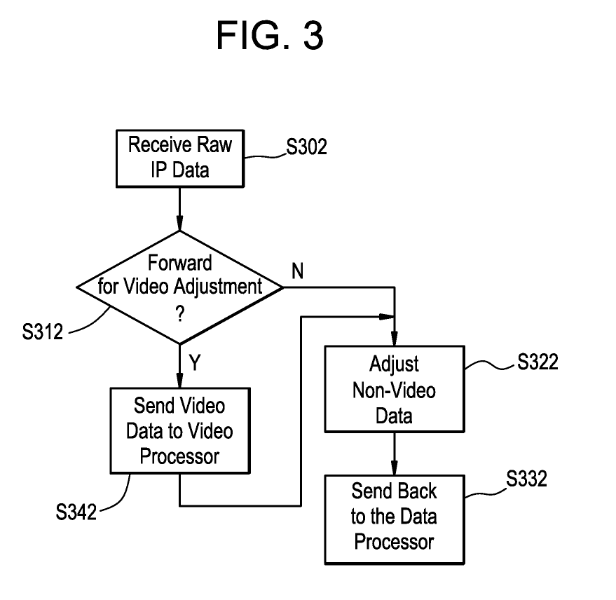

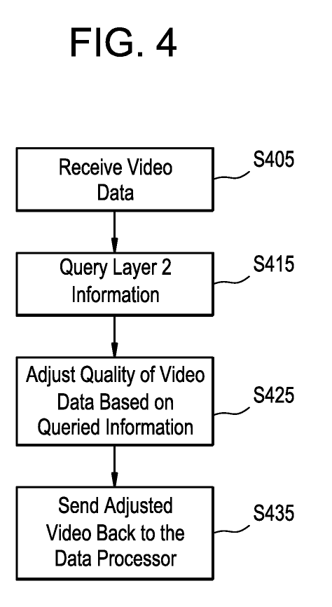

At S220, the data processor 106 redirects/forwards the raw IP data packet, which includes the video data to the packet inspector 107 of the BBU 103. The BBU 103, which implements the functionalities of the data processor 106, the packet inspector 107 and the video processor 108, performs processing for adjusting video data included within the received IP packet. The process for adjusting video data at S230 will be further described below with respect to FIGS. 3-4.

In the example embodiments that the BBU 103 implements the functionalities of the data processor 106 and not the packet inspector 107 and the video optimizer 108, the raw IP data packet is redirected to the component that implements the functionalities of the packet inspector 107 and the video processor 108 (the component that is co-located with the BBU 103) and S230 is implemented by the packet inspector 107 and the data processor 108 of the component.

FIG. 3 illustrates a process performed by a packet inspector of a base band unit, according to one example embodiment.

At S302, the packet inspector 107 of the BBU 103 receives the raw IP packet. The received IP packet may have been sent based on port number. In one example embodiment, the port number may be used to identify the application type of the packet (e.g., HTTP type packet, RTP packet, etc.).

As described above, the packet inspector 107 may include a DPI unit and/or a HTTP proxy server. Depending on the port number, the raw IP packet may be redirected to the HTTP proxy server or the DPI unit of the packet inspector 107 with Virtual Local Area Network (VLAN) tag of the raw IP packet appended accordingly. In one example embodiment, the VLAN tag may be an identifier of the raw IP packet used in identifying a user device to which the IP packet is ultimately sent.

At S312, the packet inspector 107 of the BBU 103 determines whether the raw IP packet is to be forwarded to the video processor 108 of the BBU 103 for video data adjustment. In one example embodiment, if the raw IP packet includes video data, then the packet inspector 107 determines that the video data of the raw IP packet is to be forwarded to the video processor 108 for adjustment. If at S312, the packet inspector 107 determines that the video data of the raw IP packet does not include video data, the packet inspector 107 adjusts non-video data of the raw IP packet at S322. Thereafter, at S332, the packet inspector 107 sends the raw IP packet back to the data processor 106.

However, if at S312, packet inspector 107 of the BBU 103 determines that the raw IP packet includes video data, then at S342, the packet inspector 107 forwards the video data of the raw IP packet to the video processor 108. Thereafter, the process may revert back to S322, where the packet inspector 107 adjusts the non-video data of the raw IP packet and thereafter sends the adjusted non-video data back to the data processor 106, at S332.

Hereinafter, the adjusting of the video data of the raw IP packet by the video processor 108 will be further described below with respect to FIG. 4.

FIG. 4 illustrates a processing for adjusting video data by a video processor of the base band unit, according to one example embodiment.

At S405, the video processor 108 of the BBU 103 receives the video data of the raw IP packet from the packet inspector 107. At S415, the video processor 108 queries information associated with Layer 2 processing performed by the data processor 106 using the VLAN tag as the identifier of the base station 101 servicing the user devices 102. In one example embodiment, by querying the information associated with Layer 2 processing performed by the data processor 106, the video processor 108 obtains the Radio Access Network (RAN) information at the local cell site 100.

In one example embodiment, the RAN information may include predicted average network throughput to any one of the exemplary user devices 102. The RAN information may further include information on overall resource utilization such as the total average physical resource (physical resource blocks PRBs in a LTE based mobile network) utilized by the user devices served by the base station 101.

In one example embodiment, the video processor 108 may periodically query the information associated with Layer 2 processing performed by the data processor 106. The periodicity of such query may be a matter of design choice and may be a reconfigurable variable. In one example embodiment, the periodicity may be set short enough (e.g., every one second or a few seconds) so as to enable optimization of the video data based on real-time or near real-time network information.

At S425, the video processor 108 adjusts the video data received at S405 based on the RAN information. For example, if the RAN information are such that the video data has to be adjusted (e.g., when signal reception at the user device from the base station is poor such that the quality of the video data has to be reduced), the video processor 108 transcodes the video data to a target video rate determined based on the real-time network throughput to the intended one or more of the user devices 102 and/or the overall average resource utilization. In one example embodiment, the video processor 108 may further adjust the video data based on characteristics of the user device 102 to which the video data is to be sent.

In one example embodiment, the adjusting of the video data my include transcoding the video data to a new video encoding rate or selecting a new video file corresponding to a new encoding rate if the encoded video is cached locally. Another method for adjusting the video data is transrating based on which the video resolution or frame rate of the video data may be adjusted.

In one example embodiment, by transcoding the video data to a target video rate, the video data may be streamed at the user device 102 without interruption and/or with higher quality when network conditions (e.g., network bandwidth) permits.

At S435, the video processor 108 sends the adjusted video data back to the data processor 106.

Referring back to FIG. 2, at S230, the data processor 106 of the BBU 103 receives the data back from the packet inspector 107 and/or the video processor 108. As described above, the data received back from the packet inspector 107 may include non-video data adjusted by the packet inspector 107 and/or video data adjusted by the video processor 108.

Upon receiving the video data at S230, the data processor 106 may perform further processing on the received video data at S240 (e.g., perform Layer 2 processing on the received data). For example, the data processor 106 may initiate packet data convergence protocol (PDCP) processing of the data flow (e.g., IP packet) that includes the adjusted video data. Furthermore, the data processor 106 may further combine the adjusted non-video data received from the packet inspector 107 with the adjusted video data received from the video processor 108 and/or video data that the packet inspector 107 has determined to not require any adjustment.

At S250, the data processor 106 of the BBU 103 may send the processed data flow to the base station 101 and/or any other base station that serves the user device to which the processed data flow is to be sent (e.g., one or more of user devices 102). The determination of the correct user device(s) to which the data flow is to be sent and hence the correct base station(s) may be based on the VLAN tag of the IP packet, which indicates the identifier of the user device(s) to which the IP packet, including the optimized video data is to be sent.

By performing the video data adjustment described above, at the BBU 103 (e.g., between Layer 3 and Layer 2 processing performed by the BBU 103) and taking into consideration real-time RAN conditions of the cell site 100 and/or overall resource utilization by the user device 102, the following advantages are achieved.

Adjustment of the video data based on local RAN information provides better video Mean Opinion Score (MOS) by transcoding the video data (e.g., non-HAS video content) to the right quality level taking into account not only the device characteristics but also the actual bandwidth available to a user device (e.g., expected network throughput at the user device 102), where such local RAN information are provided/updated on a time scale of seconds, hence providing real-time RAN information. For example, when user(s) of user device(s) 102 is/are watching a video sitting by a window in a coffee shop and a truck pulls up by the window and parks, the video processor may react in real-time to the resulting signal and throughput degradation based on RAN information input for that specific video flow and lower quality and prevent stalling of the video data as the video data is being delivered to the user(s).

Adjusting the video data locally at the RAN cell site and based on the local cell site's network conditions implies terminating the TCP session from the original source (e.g., the core network 105) and a starting a new TCP session to the user device 102, much closer to the user device 102. This will significantly reduce the TCP round trip time which is known to improve the throughput of the network at the user device and hence the quality experience.

In some example embodiments, if applications provide the relevant information to the PCRF marking the video flow, the same may be signaled to the RAN through a separate Quality Class Identifier (QCI) dedicated to video data. Therefore, the need for DPI/proxy (e.g., the packet inspector 107 and/or HTTP proxy) to identify video flows for adjusting the video data may be eliminated. However, this may be possible only when applications provide relevant information to the PCRF using the Rx interface between PCRF and the application function.

Variations of the example embodiments are not to be regarded as a departure from the spirit and scope of the example embodiments, and all such variations as would be apparent to one skilled in the art are intended to be included within the scope of this disclosure.

What is claimed:

1. A base band unit comprising:
a processor configured to,
receive video data,
adjust a quality of the video data based on network information corresponding to a cell site serviced by a base station, and
send the adjusted video data to the base station.

2. The base band unit of claim 1, wherein the processor is configured to perform a first processing of the received video data, adjust the quality of the video data and perform a second processing of the video data having the adjusted quality, prior to sending the adjusted video data to the base station.

3. The base band unit of claim 2, wherein the first processing includes removing tunnel headers of an Internet Protocol (IP) packet that includes the video data, upon receiving the IP packet.

4. The base band unit of claim 3, wherein the processor is further configured to,
determine whether to perform the adjusting of the quality of the video data upon removing the tunnel headers, and
adjust the quality of the video data upon determining that the quality of the video data is to be adjusted.

5. The base band unit of claim 1, wherein the baseband unit and the base station are co-located in the same geographical location.

6. The base band unit of claim 1, wherein the network information includes at least one of a real-time network throughput to a user device to which the video data is to be transmitted and is served by the base station, and overall resource utilization by user devices at a cell site served by the base station.

7. The base band unit of claim 1, wherein the processor is configured to adjust the quality of the video data to provide an uninterrupted streaming of the video data at a user device serviced by the base station.

8. The base band unit of claim 1, wherein the processor is further configured to,
query information associated with Layer 2 processing performed by the processor for the network information, and
adjust the quality of the video data based on the queried network information.

9. The base band unit of claim 8, wherein the processor is configured to periodically query the information associated with the Layer 2 processing.

10. The base band unit of claim 1, wherein the processor is configured to adjust the quality of the video data based on the network information as well as characteristics of a user device to which the video data is to be sent.

11. A method comprising:
receiving video data by a processor;
adjusting a quality of the video data based on network information corresponding to a cell site serviced by a base station; and
sending the optimized video data to the base station.

12. The method of claim 11, further comprising:
first processing the received video data, and
second processing of the video data, wherein
the adjusting adjust the quality of the video data after the first processing but prior to the second processing, and
the second processing second processes the video data whose quality is adjusted before the sending sends the video data to the base station.

13. The method of claim 12, wherein
the first processing includes removing tunnel headers of an Internet Protocol (IP) packet that includes the video data, upon receiving the IP packet, and
the method further includes determining whether the quality of the video data of the IP packet is to be adjusted, wherein the adjusting adjusts the quality of the video data if the determining determines that the quality of the video data is to be adjusted.

14. The method of claim 11, wherein the network information includes at least one of a real-time network throughput at a user device to which the video data is to be transmitted and is served by the base station, overall resource utilization by user devices at a cell site served by the base station and characteristics of a user device to which the video data is to be sent.

15. The method of claim 11, wherein the adjusting adjusts the quality of the video data to provide an uninterrupted streaming of the video data at a user device services by the base station.

16. The method of claim 11, further comprising:
querying information associated with Layer 2 processing performed by the processor for the network information, wherein the adjusting adjusts the quality of the video data based on the queried network information.

17. The method of claim 16, wherein the querying periodically queries the information associated with the Layer 2 processing.

18. A processing unit configured to,
receive video data from a base band unit,
adjust a quality of the video data based on network information corresponding to a cell site serviced by a base station associated with the base band unit, and
send the adjusted video data to the base band unit.

19. The processing unit of claim 18, wherein the processing unit and the base band unit are co-located in the same unit.

20. The processing unit of claim 18, wherein
the base band unit is configured to remove tunnel headers of an IP packet received at the base band unit, and
the processor is configured to
determine whether to perform the adjusting of the quality of the video data of the IP packet, and
adjust the quality of the video data upon determining that the quality of the video data is to be adjusted.
